(19) United States
(12) Patent Application Publication
(10) Pub. No.: US 2026/0237349 A1
(43) Pub. Date: Aug. 13, 2026

(54) DISPLAY PANEL, DRIVING METHOD, DRIVING CIRCUIT, AND DISPLAY DEVICE

(71) Applicants: Chengdu BOE Optoelectronics Technology Co., Ltd., Chengdu, Sichuan (CN); BOE TECHNOLOGY GROUP CO., LTD., Beijing (CN)

(72) Inventors: Haigang QING, Beijing (CN); Gukhwan SONG, Beijing (CN); Hai ZHENG, Beijing (CN); Benlian WANG, Beijing (CN); Ming HU, Beijing (CN); Haijun QIU, Beijing (CN)

(73) Assignees: Chengdu BOE Optoelectronics Technology Co., Ltd., Chengdu, Sichuan (CN); BOE TECHNOLOGY GROUP CO., LTD., Beijing (CN)

(21) Appl. No.: 19/498,095

(22) PCT Filed: Oct. 21, 2024
(86) PCT No.: PCT/CN2024/126156

§ 371 Date: Dec. 30, 2025

(30) Foreign Application Priority Data
Nov. 30, 2023 (CN) 202311622386.5

(51) Int. Cl. G09G 3/3233

(52) U.S. Cl. CPC G09G 3/3233; G09G 2300/0819; G09G 2310/08; G09G 2320/0233; G09G 2320/0257; G09G 2330/021

(57) ABSTRACT

A display panel includes pixel circuits. The pixel circuit includes a first light-emitting control unit between first and second nodes, a second light-emitting control unit between third and fourth nodes, a driving unit to the second, third and fifth nodes, a first data writing unit between the third and sixth nodes, an isolation unit between the fifth and sixth nodes, and a light-emitting unit. The first node receives a first driving signal. The first data writing unit includes an oxide transistor. The isolation unit includes a polysilicon transistor. One end of the light-emitting unit is electrically connected to the fourth node, and the other end receives a second driving signal. There is a first time period in which the first data writing unit and the isolation unit are both turned on, and after that time period, the isolation unit is turned off before the first data writing unit.

### CROSS-REFERENCE TO RELATED APPLICATION(S)

This application is a national phase entry under 35 USC 371 of International Patent Application No. PCT/CN2024/126156, filed on Oct. 21, 2024, which claims priority to Chinese Patent Application No. 202311622386.5, filed on Nov. 30, 2023, which are incorporated herein by reference in their entirety.

### TECHNICAL FIELD

The present disclosure relates to the field of display technologies, and in particular, to a display panel, a driving method, a driving circuit, and a display device.

### BACKGROUND

With the increasing maturity of semiconductor display technologies, such as AMOLED (active-matrix organic light-emitting diode) and OLED (organic light-emitting diode), the diverse demands of today's market have placed higher requirements on display screens in terms of frame rate, resolution, and durability.

Pixel circuits manufactured using a process that combines LTPS (low temperature poly-silicon) and oxide technology have gained widespread adoption because they combine the low leakage of oxide transistors with the high maturity of the LTPS process. However, since oxide transistors are sensitive to temperature and voltage fluctuations, they are prone to characteristic shift problems, which causes changes in the driving current in the pixel circuit, resulting in uneven brightness and darkness of the display screen and reducing the display effect of the display screen.

### SUMMARY

The present disclosure provides a display panel, a driving method, a driving circuit, and a display device.

In a first aspect, embodiments of the present disclosure provide a display panel including a plurality of pixel circuits. A pixel circuit of the plurality of pixel circuits includes:
a first light-emitting control unit, where the first light-emitting control unit is electrically connected between a first node in the pixel circuit and a second node in the pixel circuit, and the first node is configured to receive a first driving signal;
a second light-emitting control unit, where the second light-emitting control unit is electrically connected between a third node in the pixel circuit and a fourth node in the pixel circuit;
a driving unit, where the driving unit is electrically connected to the second node, the third node and a fifth node in the pixel circuit;
a first data writing unit, where the first data writing unit is electrically connected between the third node and a sixth node in the pixel circuit, and the first data writing unit includes an oxide transistor;
an isolation unit, where the isolation unit is electrically connected between the fifth node and the sixth node, and the isolation unit includes a polysilicon transistor; and
a light-emitting unit, where one end of the light-emitting unit is electrically connected to the fourth node, and another end of the light-emitting unit is configured to receive a second driving signal;
where there is a first time period in which the first data writing unit and the isolation unit are both turned on, and after the first time period, the isolation unit is turned off before the first data writing unit.

In some implementations, the oxide transistor of the first data writing unit is in a saturation region in the first time period.

In some implementations, the oxide transistor of the first data writing unit is an N-type; and
the polysilicon transistor of the isolation unit is P-type;
where before the first time period, a rising edge of a gate signal of the oxide transistor is located before a falling edge of a gate signal of the polysilicon transistor; and
after the first time period, a falling edge of the gate signal of the oxide transistor is located after a rising edge of the gate signal of the polysilicon transistor.

In some implementations, the pixel circuit further includes:
a first reset unit, where the first reset unit is electrically connected to the sixth node, and the first reset unit is configured to transmit a first reset signal to the sixth node;
where there is a second time period in which the first data writing unit and the first reset unit are both turned on, before the second time period, the first reset unit is turned on before the first data writing unit, after the second time period, the first reset unit is turned off before the first data writing unit, and the second time period is non-overlapping with the first time period.

In some implementations, before the second time period, there is at least one third time period in which the isolation unit and the first reset unit are both turned on, and before each third time period, the first reset unit is turned on before the isolation unit.

In some implementations, the pixel circuit further includes:
a second data writing unit, where the second data writing unit is electrically connected to the second node, and the second data writing unit is configured to transmit a data signal to the second node;
where the second data writing unit and the isolation unit have a same on or off state.

In some implementations, the pixel circuit further includes:
a second reset unit, where the second reset unit is electrically connected to the fourth node, and the second reset unit is configured to transmit a second reset signal to the fourth node;
a third reset unit, where the third reset unit is electrically connected to the second node, and the third reset unit is configured to transmit a third reset signal to the second node; and
a capacitor, where one end of the capacitor is electrically connected to the first node, and another end of the capacitor is electrically connected to the fifth node.

In some implementations, the first reset unit includes an oxide transistor; and/or the second data writing unit includes a polysilicon transistor; and/or
the second reset unit includes a polysilicon transistor; and/or the third reset unit includes a polysilicon transistor; and/or
the first light-emitting control unit includes a polysilicon transistor; and/or
the second light-emitting control unit includes a polysilicon transistor; and/or the driving unit includes a polysilicon transistor.

In some implementations, the driving unit is a P-type polysilicon transistor, and a potential of the third reset signal is greater than a potential of the first driving signal; or
the driving unit is an N-type polysilicon transistor, and the potential of the third reset signal is less than the potential of the first driving signal.

In some implementations, the first light-emitting control unit is turned on for at least one row scanning duration before the second light-emitting control unit.

In a second aspect, embodiments of the present disclosure provide a driving method for a display panel, applied to the display panel according to any implementation of the first aspect. The driving method includes:
controlling the first data writing unit and the isolation unit to be turned on, enabling that there is the first time period in which the first data writing unit and the isolation unit are both turned on, and transmitting writing data to the driving unit;
controlling, after the first time period, the isolation unit to be turned off first and then the first data writing unit to be turned off; and
controlling the first light-emitting control unit and the second light-emitting control unit to be turned on, enabling the light-emitting unit to emit light under action of the first driving signal and the second driving signal.

In some implementations, the pixel circuit includes a first reset unit, and there is a second time period in which the first data writing unit and the first reset unit are both turned on and the driving method further includes:
controlling, before the second time period, the first reset unit to be turned on first; and
controlling, after the second time period, the first reset unit to be turned off first;
where the second time period lasts for at least one row scanning duration.

In some implementations, before the second time period, there is at least one third time period in which the isolation unit and the first reset unit are both turned on, and the driving method further includes:
controlling, before the second time period, the first reset unit to be turned on to transmit a first reset signal to the sixth node; and
controlling, after the first reset unit is turned on, the isolation unit to be turned on for the at least one third time period to transmit the first reset signal to the fifth node, where each third time period lasts for at least one row scanning duration.

In some implementations, the driving method further includes:
controlling, before controlling the first light-emitting control unit and the second light-emitting control unit to be turned on, the first light-emitting control unit to be turned on for at least one row scanning duration earlier than the second light-emitting control unit.

In a third aspect, embodiments of the present disclosure provide a driving circuit, for performing the driving method for the display panel according to any implementation of the second aspect.

In some implementations, the driving circuit includes: a light-emitting array driving circuit, electrically connected to the pixel circuit and configured to provide a light-emitting control signal to the pixel circuit; a first gate array driving circuit, electrically connected to the pixel circuit and configured to provide a first gate driving signal to the pixel circuit; and a second gate array driving circuit, electrically connected to the pixel circuit and configured to provide a second gate driving signal to the pixel circuit.

In a fourth aspect, embodiments of the present disclosure provide a display device, including the display panel according to any implementation of the first aspect, and/or the driving circuit according to the third aspect.

In summary, the display panel provided by the present disclosure includes a plurality of pixel circuits. A pixel circuit of the plurality of pixel circuits includes: a first light-emitting control unit, the first light-emitting control unit being electrically connected between a first node in the pixel circuit and a second node in the pixel circuit, and the first node being configured to receive a first driving signal; a second light-emitting control unit, the second light-emitting control unit being electrically connected between a third node in the pixel circuit and a fourth node in the pixel circuit; a driving unit, the driving unit being electrically connected to the second node, the third node and a fifth node in the pixel circuit; a first data writing unit, the first data writing unit being electrically connected between the third node and a sixth node in the pixel circuit, and the first data writing unit including an oxide transistor; an isolation unit, the isolation unit being electrically connected between the fifth node and the sixth node, and the isolation unit including a polysilicon transistor; and a light-emitting unit, one end of the light-emitting unit being electrically connected to the fourth node, and the other end of the light-emitting unit being configured to receive a second driving signal; where there is a first time period in which the first data writing unit and the isolation unit are both turned on, and after the first time period, the isolation unit is turned off before the first data writing unit. In the present disclosure, the isolation unit is provided between the first data writing unit and the driving unit, and the isolation unit includes a polysilicon transistor. In a case where it is necessary to stop writing charge to the fifth node, the polysilicon transistor in the isolation unit is turned off first, and then the oxide transistor in the first data write unit is turned off.

Correspondingly, the driving method, the driving circuit and the display device that are provided by the present disclosure also have the above technical effects.

### BRIEF DESCRIPTION OF THE DRAWINGS

FIG. 1 is a schematic structural block diagram of a pixel circuit provided in embodiments of the present disclosure;

FIG. 2 is a diagram showing a relationship of the threshold voltage of an oxide transistor and the brightness of an OLED provided in embodiments of the present disclosure;

FIG. 3 is a schematic structural diagram of a pixel circuit provided in embodiments of the present disclosure;

FIG. 4 is a schematic signal timing diagram of a pixel circuit provided in embodiments of the present disclosure;

FIG. 5 is a schematic structural block diagram of another pixel circuit provided in embodiments of the present disclosure;

FIG. 6 is a schematic structural diagram of another pixel circuit provided in embodiments of the present disclosure;

FIG. 7 is a schematic signal timing diagram of another pixel circuit provided in embodiments of the present disclosure;

FIG. 8 is a schematic structural block diagram of yet another pixel circuit provided in embodiments of the present disclosure;

FIG. 9 is a schematic structural diagram of yet another pixel circuit provided in embodiments of the present disclosure;

FIG. 10 is a schematic signal timing diagram of yet another pixel circuit provided in embodiments of the present disclosure;

FIG. 11 is a schematic structural diagram of still yet another pixel circuit provided in embodiments of the present disclosure;

FIG. 12 is a schematic signal timing diagram of still yet another pixel circuit provided in embodiments of the present disclosure;

FIG. 13 is a schematic flowchart of a driving method provided in embodiments of the present disclosure;

FIG. 14 is a schematic structural block diagram of the connection relationship of a driving circuit provided in embodiments of the present disclosure; and

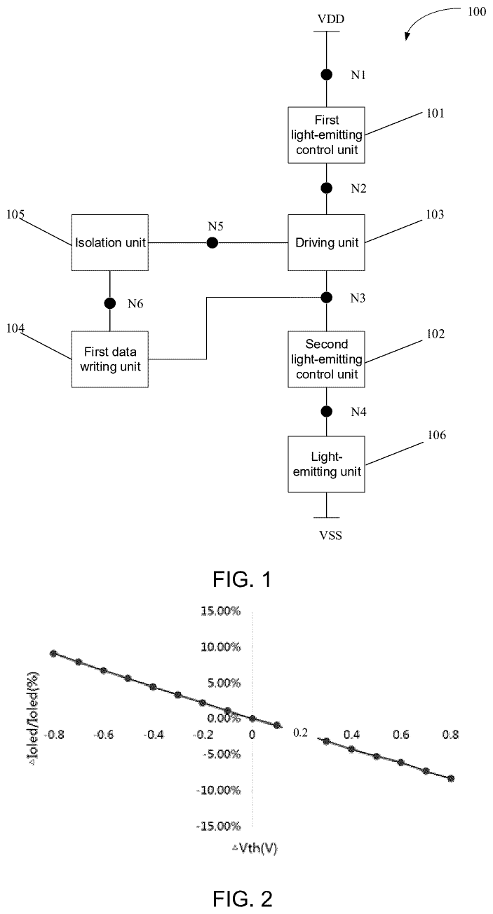

FIG. 15 is a schematic structural diagram of a display device provided in embodiments of the present disclosure;
where the corresponding relationships between component names and reference signs in FIGS. 1, 3, 5, 6, 8, 9, 11, 14, and 15 are as follows:
1000: Display device; 100: Pixel circuit, 200: Light-emitting array driving circuit, 300: First gate array driving circuit, 400: Second gate array driving circuit; 101: First light-emitting control unit, 102: Second light-emitting control unit, 103: Driving unit, 104: First data writing unit, 105: Isolation unit, 106: Light-emitting unit, 107: First reset unit, 108: Second data writing unit, 109: Second reset unit, 110: Third reset unit; N1: First node, N2: Second node, N3: Third node, N4: Fourth node, N5: Fifth node, N6: Sixth node, T1, T2 and T3: Transistor, T4: Oxide transistor, T5: Polysilicon transistor, T6: Oxide transistor, T7, T8 and T9: Transistor, VDD: First driving signal, VSS: Second driving signal, Vinit1: First reset signal, Vinit2: Second reset signal, Vinit3: Third reset signal, Data: Data signal, Ngate: First gate driving signal, Pgate: Second gate driving signal, Reset_n: First reset driving signal, Reset_p: Second reset driving signal, EM: Light-emitting control signal, EM1: First light-emitting control signal, EM2: Second light-emitting control signal.

### DETAILED DESCRIPTION

The terms “first,” “second,” “third,” “fourth,” etc., (if any) in the description and claims of the present disclosure and the above drawings are used to distinguish similar objects and are not necessarily used to describe a specific order or sequence. It can be understood that the terms used herein are interchangeable under appropriate circumstances, such that the embodiments described herein can be implemented in an order different from that illustrated or described herein. In addition, the terms “comprise” and “include” and any variations thereof are intended to cover a non-exclusive inclusion. For example, a process, method, system, product or apparatus that includes a series of steps or units is not necessarily limited to those steps or units expressly listed but may include other steps or units not expressly listed or inherent to such process, method, product or apparatus. The technical solutions in the embodiments of the present disclosure will be described clearly and completely with reference to the accompanying drawings in the embodiments of the present disclosure. Obviously, the described embodiments are merely some but not all of embodiments of the present disclosure.

In a first aspect, embodiments of the present disclosure provide a display panel, including a plurality of pixel circuits. FIG. 1 is a schematic structural block diagram of a pixel circuit provided in embodiments of the present disclosure. As shown in FIG. 1, the pixel circuit 100 includes: a first light-emitting control unit 101, the first light-emitting control unit 101 being electrically connected between a first node N1 and a second node N2, and the first node N1 being used to receive a first driving signal VDD; a second light-emitting control unit 102, the second light-emitting control unit 102 being electrically connected between a third node N3 and a fourth node N4; a driving unit 103, the driving unit 103 being electrically connected to the second node N2, the third node N3 and a fifth node N5; a first data writing unit 104, the first data writing unit 104 being electrically connected between the third node N3 and a sixth node N6, and the first data writing unit 104 including an oxide transistor; an isolation unit 105, the isolation unit 105 being electrically connected between the fifth node N5 and the sixth node N6, and the isolation unit 105 including a polysilicon transistor; and a light-emitting unit 106, one end of the light-emitting unit 106 being electrically connected to the fourth node N4, and the other end being used to receive a second driving signal VSS; where there is a first time period in which the first data writing unit 104 and the isolation unit 105 are both turned on, and after the first time period, the isolation unit 105 is turned off before the first data writing unit 104.

It will be noted that the first light-emitting control unit 101 is used to control the connection and disconnection between the first node N1 and the second node N2, and in a case where the first node N1 and the second node N2 are connected, the first driving signal VDD is written to the second node N2. The second light-emitting control unit 102 is used to control the connection and disconnection between the third node N3 and the fourth node N4. The driving unit 103 is used to control the connection and disconnection between the second node N2 and the third node N3 under the action of the fifth node N5. In a case where the first light-emitting control unit 101, the second light-emitting control unit 102 and the driving unit 103 are all turned on, the light-emitting unit 106 emits light under the action of the first driving signal VDD and the second driving signal VSS. Here, the isolation unit 105 is used to control the connection and disconnection between the fifth node N5 and the sixth node N6, the first data writing unit 104 is used to control the connection and disconnection between the third node N3 and the sixth node N6, and the first time period represents a time period in which the isolation unit 105 and the first data writing unit 104 are both turned on. In the first time period, the potential of the third node N3 can be written to the fifth node N5 through the first data writing unit 104 and the isolation unit 105. After the first time period, the isolation unit 105 is first turned off, and then the first data writing unit 104 is turned off. Furthermore, the isolation unit 105 includes a polysilicon transistor, and the first data writing unit 104 includes an oxide transistor.

It can be understood that oxide transistors, such as IGZO (indium gallium zinc oxide) transistors, have low electrical leakage characteristics. In the pixel circuit 100, an oxide transistor may be employed as an isolation switch for a gate of a driving transistor used for control signal writing, which may prevent the charge of the gate capacitance from being lost when the driving transistor is in an on state, thereby ensuring the on state stability of the driving transistor. However, due to the low maturity of the current process of oxide transistors and the relatively active properties of oxides, the threshold voltage characteristics of the oxide transistors are prone to shift, especially in the case of voltage fluctuations. Thus, at the moment when the oxide transistor is turned off, the threshold voltage may shift positively or negatively. For example, FIG. 2 is a diagram showing a relationship of the threshold voltage of an oxide transistor and the brightness of an OLED provided in embodiments of the present disclosure, and in FIG. 2, the horizontal axis ΔVth represents the fluctuation of the threshold voltage of the oxide transistor, in units of V (volts), and the vertical axis Δloled/loled represents the percentage change in the brightness of the OLED. As shown in FIG. 2, in a case where the oxide transistor is in a forward bias, the threshold voltage of the oxide transistor increases, resulting in an increase in the amount of charge written to the gate of the driving transistor, a decrease in the absolute value of a gate-source voltage of the driving transistor, and a decrease in a driving current generated by the driving transistor, and consequently, the brightness of the OLED is darker than that under normal conditions. Conversely, in a case where the oxide transistor is in a reverse bias, the threshold voltage of the oxide transistor decreases, resulting in a decrease in the amount of charge written to the gate of the driving transistor, an increase in the absolute value of the gate-source voltage of the driving transistor, and an increase in the driving current generated by the driving transistor, and consequently, the brightness of the OLED is brighter than that of under normal conditions. Therefore, based on the shift in the threshold voltage of the oxide transistor, the display screen will exhibit uneven horizontal stripes of brightness and darkness.

In the embodiments of the present disclosure, the isolation unit 105 is provided between the first data writing unit 104 and the driving unit 103, and the isolation unit 105 includes a polysilicon transistor. After the first time period, that is, in a case where it is necessary to stop writing charge to the fifth node N5, the polysilicon transistor in the isolation unit 105 is first turned off, and then the oxide transistor of the first data writing unit 104 is turned off. Polysilicon transistors, especially low-temperature polysilicon transistors, have a mature manufacturing process. A semiconductor layer of the polysilicon transistor is made of polysilicon, which is more stable, has stronger binding force on electrons, and is not easily affected by the external environment. Oxide transistors are less stable. After long-term operation, the device temperature rises, the electron mobility rises, and the binding force on electrons is further reduced. Therefore, in a case where the gate-source voltage of the transistor fluctuates, it is particularly easy to cause charge accumulation at defects between the semiconductor layer and the oxide layer, resulting in charging and discharging, causing the threshold voltage to shift, and causing the potential written to the gate node of the driving transistor to change, thereby ultimately forming the uneven brightness and darkness of the display screen. Therefore, in the embodiments of the present disclosure, the polysilicon transistor in the isolation unit 105 is first turned off. Utilizing the characteristic of high stability of the polysilicon transistor, the threshold voltage is not easily shifted in a case where the gate-source voltage fluctuates. As a result, at the turn-off moment, the change in the potential written to the gate node of the driving transistor is greatly reduced. Thus, the driving current generated by the driving transistor has a high degree of reproducibility, and the brightness of the light-emitting unit will not become darker or brighter, which may alleviate the technical problem of uneven brightness and darkness of the display screen and improve the uniformity of the display image. It will be noted that the first light-emitting control unit 101, the second light-emitting control unit 102, the isolation unit 105 and the first data writing unit 104 may be controlled by a driving chip or a processor in the display panel, and the specific control method is not limited.

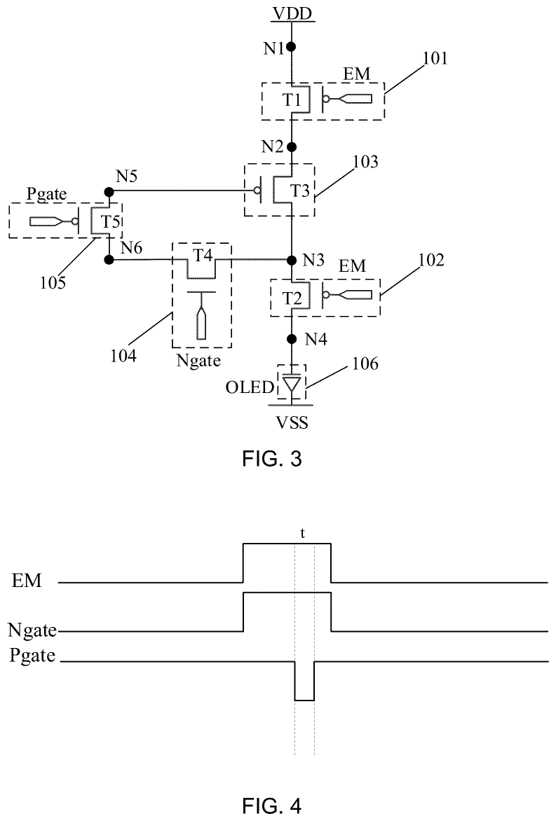

For example, FIG. 3 is a schematic structural diagram of a pixel circuit provided in embodiments of the present disclosure. As shown in FIG. 3, the first light-emitting control unit 101 includes a transistor T1, the second light-emitting control unit 102 includes a transistor T2, the driving unit 103 includes a transistor T3, the first data writing unit 104 includes an oxide transistor T4, the isolation unit 105 includes a polysilicon transistor T5, and the light-emitting unit 106 includes an OLED. Here, the oxide transistor T4 is an N-type transistor as example, while the transistor T1, the transistor T2, the transistor T3, and the polysilicon transistor T5 are P-type transistors as example.

FIG. 4 is a schematic signal timing diagram of a pixel circuit provided in embodiments of the present disclosure. As shown in combination with FIGS. 3 and 4, under a high potential of a light-emitting control signal EM, the transistor T1 and the transistor T2 are turned off, under a high potential of a first gate driving signal Ngate, the oxide transistor T4 is turned on, and under a low potential of a second gate driving signal Pgate, the polysilicon transistor T5 is turned on. The first time period in which the oxide transistor T4 and the polysilicon transistor T5 are both turned on is a time period t in FIG. 4. In the time period t, the potential of the third node N3 is written to the fifth node N5 through the sixth node N6, and the potential of the fifth node N5 is stored in the gate capacitance of the transistor T3. After the time period t, under the low potential of the second gate driving signal Pgate, the polysilicon transistor T5 is turned off. After the polysilicon transistor T5 is turned off, the oxide transistor T4 may be turned off.

It is easy to understand that a turn-off interval between the polysilicon transistor T5 and the oxide transistor T4 can be determined according to actual conditions, so as to ensure that the oxide transistor T4 is turned off after the polysilicon transistor T5 is completely turned off.

In accordance with some embodiments, the oxide transistor of the first data writing unit 104 in FIGS. 1 and 3 is in a saturation region in the first time period.

It will be noted that when the oxide transistor in the first data writing unit 104 is in the saturation region, a source-drain current is little affected by the gate potential. Therefore, when writing data to the fifth node N5 in the above-mentioned first time period, it is possible to prevent changes to the written data caused by fluctuations in the first gate driving signal Ngate, thereby improving the accuracy of the amount of the charge written to the gate capacitance of the driving transistor in the driving unit 103, and then improving the accuracy of the driving current, so that the brightness of the OLED may be accurately reproduced.

In accordance with some embodiments, the oxide transistor of the first data writing unit 104 is N-type, and the polysilicon transistor of the isolation unit 105 is P-type, where before the first time period, a rising edge of a gate signal of the oxide transistor is located before a falling edge of a gate signal of the polysilicon transistor; and after the first time period, a falling edge of the gate signal of the oxide transistor is located after a rising edge of the gate signal of the polysilicon transistor.

For example, in combination with FIGS. 3 and 4, before the first time period, i.e., the time period t in FIG. 4, the oxide transistor T4 of the first data writing unit 104 starts to be turned on at a rising edge of the first gate driving signal Ngate, and the polysilicon transistor T5 of the isolation unit 105 starts to be turned on at a falling edge of the second gate driving signal Pgate, and the rising edge of the first gate driving signal Ngate precedes the falling edge of the second gate driving signal Pgate; after the time period t, the polysilicon transistor T5 of the isolation unit 105 is turned off at a rising edge of the second gate driving signal Pgate, and the oxide transistor T4 of the first data writing unit 104 is turned off at a falling edge of the first gate driving signal Ngate, and the falling edge of the first gate driving signal Ngate is after the rising edge of the second gate driving signal Pgate. By staggering the turn-on and turn-off of the oxide transistor T4 and the turn-on and turn-off of the polysilicon transistor T5, it is possible to prevent the oxide transistor T4 from causing the threshold voltage drift during voltage fluctuations at the instant, thereby avoiding changes in the potential written to the fifth node N5.

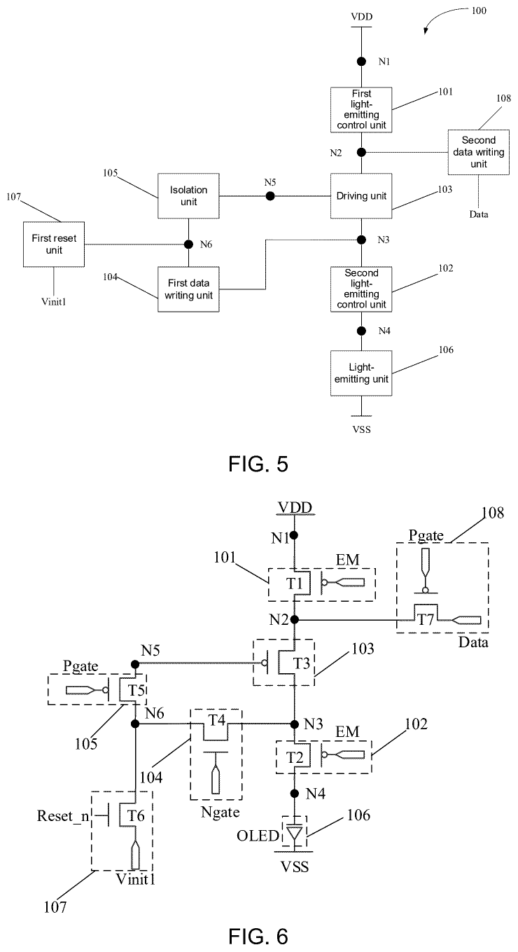

In accordance with some embodiments, FIG. 5 is a schematic structural block diagram of another pixel circuit provided in embodiments of the present disclosure. As shown in FIG. 5, the pixel circuit 100 further includes: a first reset unit 107. The first reset unit 107 is electrically connected to the sixth node N6, and the first reset unit 107 is used to transmit a first reset signal to the sixth node N6. Here, there is a second time period in which the first data writing unit 104 and the first reset unit 107 are both turned on; and before the second time period, the first reset unit 107 is turned on before the first data writing unit 104, after the second time period, the first reset unit 107 is turned off before the first data writing unit 104, and the second time period is non-overlapping with the first time period.

It will be noted that the first reset unit 107 is used to transmit the first reset signal Vinit1 to the sixth node N6 under the action of a control signal. In the second time period in which the first data writing unit 104 and the first reset unit 107 are both turned on, the first reset signal Vinit1 is written to the third node N3. Since in the first time period, the first data writing unit 104 and the isolation unit 105 are both turned on to write the potential of the third node N3 to the fifth node N5, therefore, in the first time period, the first reset unit 107 cannot write the first reset signal Vinit1 to the third node N3, and the first time period cannot overlap with the second time period.

For example, FIG. 6 is a schematic structural diagram of another pixel circuit provided in embodiments of the present disclosure. As shown in FIG. 6, the first reset unit 107 includes a transistor T6, taking the transistor T6 as N-type as an example, a gate of the transistor T6 receives a first reset driving signal Reset_n, one of a source and a drain is electrically connected to the sixth node N6, and the other receives the first reset signal Vinit1.

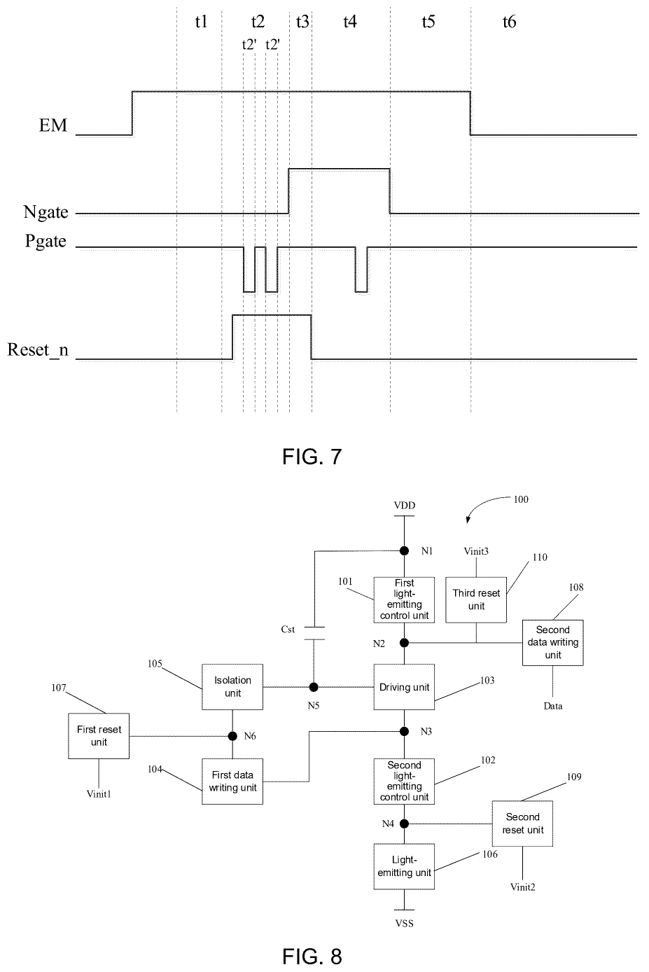

FIG. 7 is a schematic signal timing diagram of another pixel circuit provided in embodiments of the present disclosure. As shown in combination with FIGS. 6 and 7, in a time period t3, i.e., the above-mentioned second time period, the first reset driving signal Reset_n is at a high potential, and the transistor T6 is turned on; the first gate driving signal Ngate is at a high potential, and the oxide transistor T4 is turned on, so the first reset signal Vinit1 is written to the third node N3 to reset the third node N3.

Before a stage t3, the transistor T6 is turned on first to pre-charge the sixth node N6, so as to adjust the gate-source voltage of the oxide transistor T4 to remove the influence of residual charge in the previous frame of display images.

After the stage t3, the transistor T6 is turned off first, so as to prevent the first reset signal Vinit1 from being continuously written to the sixth node N6, thereby preventing the resetting of the fifth node N5 in the subsequent stage.

It will be noted that since the third node N3 is connected to the transistor T3 in the driving unit 103, resetting the third node N3 may adjust the threshold voltage of the transistor T3, eliminate the shift of the threshold voltage of the transistor T3 in the previous frame of display images, thereby improving the accuracy of the driving current, and then accurately reproducing the brightness of the OLED.

In accordance with some embodiments, before the second time period, there is at least one third time period in which the isolation unit 105 and the first reset unit 107 are both turned on, and before the third time period, the first reset unit 107 is turned on before the isolation unit 105.

For example, in combination with FIGS. 6 and 7, in the time period t2, the second gate driving signal Pgate is in at least one time period with the low potential, such as a time period t2′ in FIG. 7. In the time period t2′, the first reset driving signal Reset_n is in a high potential, the polysilicon transistor T5 in the isolation unit 105 and the transistor T6 in the first reset unit 107 are both turned on, and the first reset signal Vinit1 is written to the fifth node N5 through the polysilicon transistor T5.

It will be noted that setting the potential of the fifth node N5 as the first reset signal Vinit1 may clear the residual charge on the fifth node N5, adjust the gate stress of the transistor T3 in the driving unit 103 to control the threshold voltage of the transistor T3, and eliminate the shift of the threshold voltage of the transistor T3 in the previous frame of display images, thereby improving the accuracy of the driving current and the brightness reproducibility of the OLED, thereby alleviating the afterimage problem of the display screen.

The transistor T6 is turned on before the polysilicon transistor T5, to reset the sixth node N6 first, thereby clearing the residual charge on the sixth node N6 and eliminating the influence on the polysilicon transistor T5, thereby improving the accuracy of writing the first reset signal Vinit1.

There may be multiple third time periods. By resetting the potential of the fifth node N5 multiple times, the residual charge on the fifth node N5 may be more effectively cleared, and the threshold voltage of the transistor T3 may be adjusted multiple times to improve the adjustment effect.

It will be noted that clearing the residual charge on the fifth node N5 may also reduce the influence on the characteristics of the polysilicon transistor T5.

In accordance with some embodiments, as shown in FIG. 5, the pixel circuit 100 further includes: a second data writing unit 108. The second data writing unit 108 is electrically connected to the second node N2, and the second data writing unit 108 is used to transmit a data signal Data to the second node N2. Here, the second data writing unit 108 and the isolation unit 105 have the same on or off state.

It will be noted that the pixel circuit 100 further includes the second data writing unit 108, and the second data writing unit 108 is electrically connected to the second node N2. After the second data writing unit 108 is turned on, the data signal Data is written to the fifth node N5 through the driving unit 103, the first data writing unit 104 and the isolation unit 105. The second data writing unit 108 and the isolation unit 105 are connected in series in a same branch, and the second data writing unit 108 and the isolation unit 105 are functionally bound, therefore, the second data writing unit 108 and the isolation unit 105 may have the same on or off state, thereby simplifying the control logic of the display panel and reducing driving power consumption. Moreover, after the sixth node N6 is set by the first reset unit 107, the second data writing unit 108 is used to write the data signal Data to the fifth node N5, which may avoid the influence of the residual charge on the sixth node N6 on the on state of the isolation unit 105 and the first data writing unit 104, thereby improving the accuracy of writing the data signal Data.

For example, as shown in FIG. 6, the second data writing unit 108 includes a transistor T7, taking a P-type transistor as an example, a gate of the transistor T7 receives the second gate driving signal Pgate, one of a source and a drain receives the data signal Data, and the other of the source and the drain is electrically connected to the second node N2.

As shown in FIGS. 6 and 7, in the third time period t2′ of the stage t2, the transistor T7 and the polysilicon transistor T5 are both turned on under the low potential of the second gate driving signal Pgate, and the transistor T6 is turned on under the action of the first reset driving signal Reset_n to set the potential of the sixth node N6 to the first reset signal Vinit1. In this stage, the sixth node N6 is first reset to clear the residual charge thereon to eliminate the influence of the previous frame of display images.

In a stage t4, the transistor T7 and the polysilicon transistor T5 are both turned on in the first time period under the low potential of the second gate driving signal Pgate, and the data signal Data is written to the fifth node N5 through the transistor T7, the transistor T3, the transistor T4, and the transistor T5.

In some examples, the second data writing unit 108 and the isolation unit 105 are both controlled by a same driving circuit, thus saving gate lines in the display panel and reducing the width of a non-display area in the display panel.

In accordance with some embodiments, FIG. 8 is a schematic structural block diagram of yet another pixel circuit provided in embodiments of the present disclosure. As shown in FIG. 8, the pixel circuit 100 further includes: a second reset unit 109, the second reset unit 109 being electrically connected to the fourth node N4, and the second reset unit 109 being used to transmit a second reset signal Vinit2 to the fourth node N4, a third reset unit 110, the third reset unit 110 being electrically connected to the second node N2, and the third reset unit 110 being used to transmit a third reset signal Vinit3 to the second node N2, and a capacitor Cst, one end of the capacitor Cst being electrically connected to the first node N1, and the other end being electrically connected to the fifth node N5.

It will be noted that, in a case where the second reset unit 109 is turned on, the second reset signal Vinit2 is written to the fourth node N4; and in a case where the third reset unit 110 is turned on, the third reset signal Vinit3 is written to the second node N2. Two ends of the capacitor Cst are electrically connected to the first node N1 and the fifth node N5 respectively, and the capacitor Cst is used to store the charge for turning on the driving transistor T3.

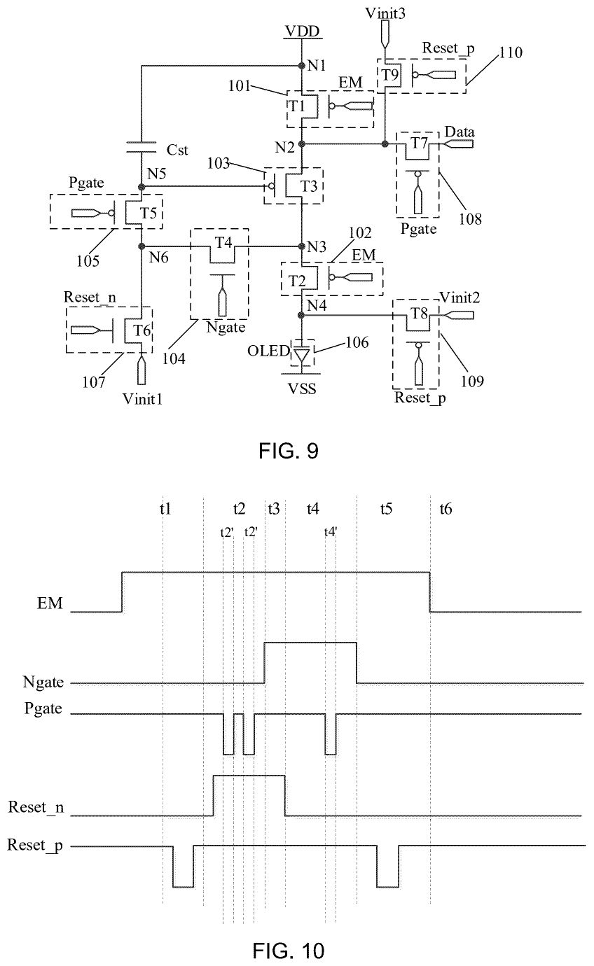

For example, FIG. 9 is a schematic structural diagram of yet another pixel circuit provided in embodiments of the present disclosure. As shown in FIG. 9, the second reset unit 109 includes a transistor T8, taking a P-type transistor as an example, a gate of the transistor T8 receives a second reset driving signal Reset_p, one of a source and a drain is connected to the fourth node N4, and the other of the source and the drain receives the second reset signal Vinit2. The third reset unit 110 includes a transistor T9, in which a gate of the transistor T9 may also receive the second reset driving signal Reset_p, one of a source and a drain is connected to the second node N2, and the other receives the third reset signal Vinit3.

FIG. 10 is a schematic signal timing diagram of yet another pixel circuit provided in embodiments of the present disclosure, and various working stages of the pixel circuit 100 provided by the embodiments of the present disclosure will be described in conjunction with FIGS. 9 and 10.

In a stage t1, the second reset driving signal Reset_p is at a low potential, the transistor T8 and the transistor T9 are turned on, and the remaining transistors are in the off state. The second reset signal Vinit2 and the third reset signal Vinit3 are written to the fourth node N4 and the second node N2 respectively to clear the residual charge after the previous frame of display images.

In a stage t2, the first reset driving signal Reset_n is at a high potential, and the transistor T6 is in the on state. In this stage, the polysilicon transistor T5 will be turned on once or multiple times under the action of the second gate driving signal Pgate, such as in the time period t2′. In the time period t2′, the first reset signal Vinit1 is written to the fifth node N5 through the transistor T6 and the polysilicon transistor T5 to clear the residual charge on the fifth node N5, thereby adjusting the gate stress of the transistor T3 in the driving unit 103 to clear the influence of the previous frame of display images on the threshold voltage of the transistor T3, thereby improving the accuracy of the driving current and the brightness reproducibility of the OLED, which may then alleviate the afterimage problem of the display screen. Setting the multiple t2′ time periods may improve the effect of adjusting the gate stress of the transistor T3.

In a stage t3, the first reset driving signal Reset_n is at a high potential, the first gate driving signal Ngate is at a high potential, the second gate driving signal Pgate is at a high potential, the transistor T6 and the oxide transistor T4 are turned on, the transistor T5 is turned off, and the third node N3 is reset by the first reset signal Vinit1, to clear the residual charge on the third node N3 and bias the threshold voltage of the transistor T3 to further clear the influence of the display image on the threshold voltage of the transistor T3

In a stage t4, the first gate driving signal Ngate is at a high potential, the first reset driving signal Reset_n is at a low potential, the oxide transistor T4 is turned on, and the transistor T6 is turned off. The second gate driving signal Pgate is at a low level in a time period t4′, to enable the polysilicon transistor T5 and the transistor T7 to be turned on, and the transistor T3 is turned on under the action of the capacitor Cst. In the time period t4′, the data signal Data is written to the capacitor Cst through the transistor T7, the transistor T3, the transistor T4, and the polysilicon transistor T5.

In a stage t5, the second reset driving signal Reset_p is at a low potential, the transistor T9 and the transistor T8 are turned on, the third reset signal Vinit3 is written to the second node N2 and the third node N3, and the second reset signal Vinit2 is written to the fourth node N4. In this stage, the third node N3 is reset, so that after the transistor T2 is turned on, the charge may be quickly transferred to the capacitor of the OLED, thereby increasing the lighting rate of the OLED. By resetting the second node N2 and the third node N3, the threshold voltage of the transistor T3 may be adjusted to improve the accuracy of the driving current.

It will be noted that in the display panel provided in the embodiments of the present disclosure, the duration of the stage t5 may also be set according to actual conditions and is not specifically limited.

In a stage t6, the light-emitting control signal EM is at a low level, the transistor T1 and the transistor T2 are turned on, and the transistor T3 is turned on under the action of the capacitor Cst. The OLED emits light under the driving current of the transistor T3. A current flowing into the OLED can be determined by the following formula:

$${I}_{OLED} = {K ( {V}_{s g} - \vert {V}_{t h} \vert )}^{2} . \qquad ( 1 )$$

Here, K represents a process design constant related to the transistor T3, V_{sg} represents the source-gate voltage of the transistor T3, Vₜₕ represents the threshold voltage of the transistor T3, and I_{OLED} represents the driving current. V_{sg} in formula (1) can be transformed into:

$${V}_{s g} = {V}_{D D} - ( {V}_{d a t a} - \vert {V}_{t h} \vert ) . \qquad ( 2 )$$

Here, V_{DD} represents the potential of the first driving signal VDD, and V_{data} represents the potential of the data signal Data.

By combining formula (1) and formula (2), formula (3) can be obtained:

$${I}_{OLED} = {K ( {V}_{D D} - {V}_{d a t a} )}^{2} . \qquad ( 3 )$$

It will be noted that after the stages t1 to t6, the display panel provided by the embodiments of the present disclosure completes the driving process of one frame of display images.

In accordance with some embodiments, as shown in FIG. 9, the first reset unit 107 includes an oxide transistor; and/or the second data writing unit 108 includes a polysilicon transistor; and/or the second reset unit 109 includes a polysilicon transistor; and/or the third reset unit 110 includes a polysilicon transistor; and/or the first light-emitting control unit 101 includes a polysilicon transistor; and/or the second light-emitting control unit 102 includes a polysilicon transistor; and/or the driving unit 103 includes a polysilicon transistor.

For example, in FIG. 9, the transistor T1, the transistor T2, the transistor T3, the transistor T7, the transistor T8, and the transistor T9 may be polysilicon transistors, and the transistor T6 may be an oxide transistor.

It will be noted that the current process of polysilicon transistors is mature, and the semiconductor layer is made of polysilicon material, so the semiconductor layer has a strong binding force on electrons. Therefore, the characteristics of the polysilicon transistors are relatively stable, and the threshold voltage is not easily affected by the external environment. However, the polysilicon transistors are more prone to electrical leakage than oxide transistors. Therefore, setting the transistor T1, the transistor T2, the transistor T3, the transistor T7, the transistor T8 and the transistor T9, which are not directly connected to the capacitor Cst, as polysilicon transistors may avoid electrical leakage defects of the polysilicon transistors. In addition, the polysilicon transistors have relatively high electron mobility and good conductivity, and are directly connected to data signals such as VDD, Data, etc., which may reduce losses.

It will be noted that since the transistor T6 is connected in series to a branch where the polysilicon transistor T5 and the capacitor Cst are located, there is a risk of electrical leakage. Therefore, the transistor T6 is set to be an oxide transistor to reduce the electrical leakage risk.

In accordance with some embodiments, as shown in FIG. 9, in a case where the driving unit 103 is a P-type polysilicon transistor, the potential of the third reset signal Vinit3 is greater than the potential of the first driving signal VDD; and in a case where the driving unit 103 is an N-type polysilicon transistor, the potential of the third reset signal Vinit3 is less than the potential of the first driving signal VDD.

For example, in the case where the driving unit 103 is a P-type polysilicon transistor, its threshold voltage is less than zero. Therefore, in order to ensure that the transistor T3 is turned on, the source or drain potential of the transistor T3 may be adjusted higher, that is, the potential of the third reset signal Vinit3 is greater than the potential of the first driving signal VDD, so that the transistor T3 is in a forward bias, enabling both the second node N2 and the third node N3 to be reset.

For example, in the case where the driving unit 103 is an N-type polysilicon transistor, its threshold voltage is greater than zero. Therefore, in order to ensure that the transistor T3 is turned on, the source or drain potential of the transistor T3 may be adjusted lowered, that is, the potential of the third reset signal Vinit3 is less than the potential of the first driving signal VDD, so that the transistor T3 is in a forward bias, enabling both the second node N2 and the third node N3 to be reset.

In accordance with some embodiments, as shown in FIGS. 1, 5 and 8, the first light-emitting control unit 101 is turned on for at least one row scanning duration before the second light-emitting control unit 102.

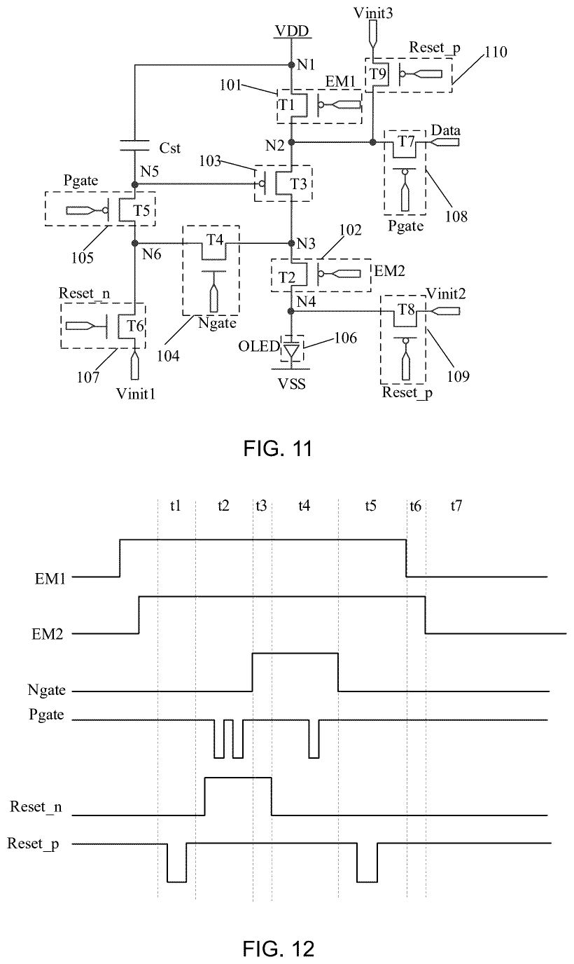

For example, FIG. 11 is a schematic structural diagram of still yet another pixel circuit provided in embodiments of the present disclosure. As shown in FIG. 11, taking P-type transistors as an example, the first light-emitting control unit 101 includes a transistor T1, and the second light-emitting control unit 102 includes a transistor T2. Gates of the transistor T1 and the transistor T2 receive a first light-emitting control signal EM1 and a second light-emitting control signal EM2, respectively.

FIG. 12 is a schematic signal timing diagram of still yet another pixel circuit provided in embodiments of the present disclosure. In combination with FIGS. 11 and 12, during the stages t1 to t5, the first light-emitting control signal EM1 and the second light-emitting control signal EM2 are both at a high potential, and the transistor T1 and the transistor T2 are turned off. The rest are the same as those described above and will not be repeated.

In a stage t6, the first light-emitting control signal EM1 is at a low level, the transistor T1 is turned on, the second light-emitting control signal EM2 is at a high level, the transistor T2 is turned off, and the second node N2 may be pre-charged.

In a stage t7, both the transistor T1 and the transistor T2 are turned on, and the OLED emits light.

It will be noted that, by pre-charging the second node N2 during the stage t6, the pre-charged charge on the second node N2 may be quickly transferred to the capacitor of the OLED in the subsequent stage t7, thereby increasing the light-emitting rate of the OLED. Moreover, the stage t6 lasts for at least one row scanning duration to ensure sufficient pre-charging. The row scanning duration can be understood as a time interval between display images of adjacent frames.

It will be noted that the pulse widths of the first light-emitting control signal EM1 and the second light-emitting control signal EM2 may be the same, and the timing difference is one row scanning duration. Therefore, in a case where a driving circuit is used to provide the first light-emitting control signal EM1 and the second light-emitting control signal EM2, every two rows of pixel circuits 100 may share one driving circuit, thereby reducing the width of the non-display area of the display panel.

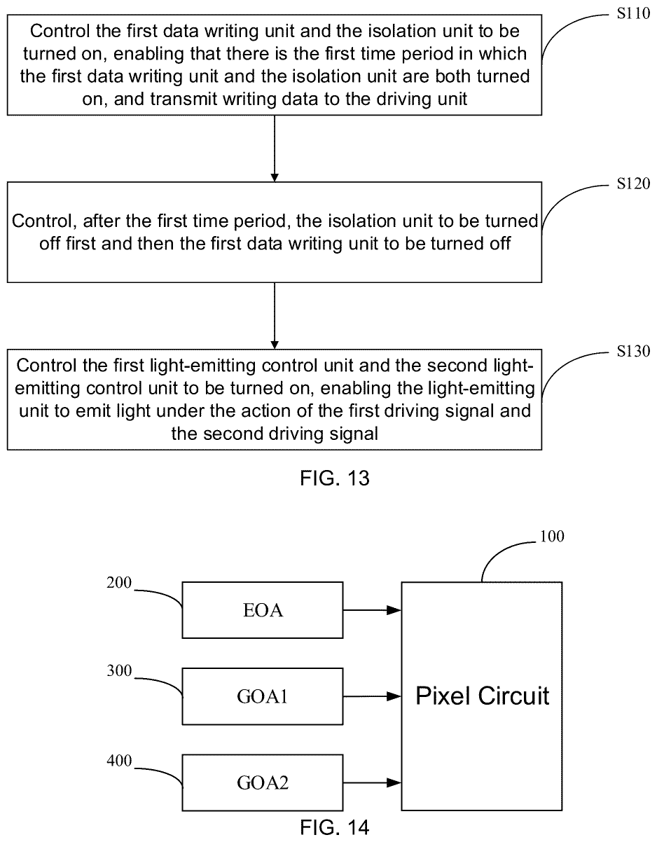

In a second aspect, embodiments of the present disclosure provide a driving method for a display panel, which is applied to the display panel according to any embodiment in the first aspect. FIG. 13 is a schematic flowchart of a driving method provided in embodiments of the present disclosure. As shown in FIG. 13, the driving method includes steps S110 to S130.

In S110, the first data writing unit 104 and the isolation unit 105 are controlled to be turned on, enabling that there is the first time period in which the first data writing unit 104 and the isolation unit 105 are both turned on, and writing data (i.e., the data signal) is transmitted to the driving unit 103.

Referring to FIG. 1, the first data writing unit 104 and the isolation unit 105 are controlled to be both turned on in the first time period, so that the writing data may be transmitted to the driving unit 103 through the third node N3, the sixth node N6 and the fifth node. As shown in FIGS. 3, 6, 9 and 11, the first data writing unit 104 includes an oxide transistor T4, the isolation unit 105 includes a polysilicon transistor T5, and the driving unit 103 may include a transistor T3.

It will be noted that the first time period represents a time period in which the first data writing unit 104 and the isolation unit 105 are both turned on, as shown in the time period t in FIG. 4. However, it is not limited to the first data writing unit 104 and the isolation unit 105 being simultaneously turned on and simultaneously turned off.

In S120, after the first time period, the isolation unit is controlled to be turned off first, and then the first data writing unit is controlled to be turned off.

For example, after the first time period has passed and the writing data has been transmitted to the driving unit 103, a branch from the third node N3 to the fifth node N5 may be disconnected.

It will be noted that the manufacturing process of polysilicon transistors is mature, and the semiconductor layer is made of polysilicon material, which has a strong binding force on electrons. The characteristics of the transistors are relatively stable, and the threshold voltage is not easily affected by the external environment. The semiconductor layer of the oxide transistor is made of oxide, which has relatively unstable characteristics, and the threshold voltage is prone to shift, especially when the voltage fluctuates. Referring to FIGS. 3, 6, 9 and 11, after the first time period, the polysilicon transistor T5 in the isolation unit 105 is first turned off, and then the oxide transistor T4 in the first data writing unit 104 is turned off. Therefore, the current flowing into the fifth node N5 will not produce a sudden change due to the possible threshold voltage shift of the oxide transistor T4, preventing the gate-source voltage of the driving transistor in the driving unit 103 from increasing or decreasing, so that the driving current generated by the driving unit 103 will not change, and the brightness of the OLED will not become darker or brighter, thereby alleviating the technical problem of uneven brightness and darkness of the display screen.

In S130, the first light-emitting control unit 101 and the second light-emitting control unit 102 are controlled to be turned on, enabling the light-emitting unit 106 to emit light under the action of the first driving signal and the second driving signal.

For example, after the isolation unit 105 is turned off, the first light-emitting control unit 101 and the second light-emitting control unit 102 are controlled to be turned on, and the light-emitting unit 106 emits light under the action of the first driving signal VDD and the second driving signal VSS.

It will be noted that the driving method provided in the embodiments of the present disclosure is also applicable to the embodiments of FIGS. 6 and 7, the embodiments of FIGS. 9 and 10, and the embodiments of FIGS. 11 and 12.

In accordance with some embodiments, as shown in FIG. 5, in a case where the pixel circuit 100 includes a first reset unit 107, and there is a second time period in which the first data writing unit 104 and the first reset unit 107 are both turned on, the driving method further includes: controlling, before the second time period, the first reset unit to be turned on first; and controlling, after the second time period, the first reset unit 107 to be turned off first; where the second time period lasts for at least one row scanning duration.

For example, in combination with FIGS. 6 and 7, the first reset unit 107 includes a transistor T6. The above-mentioned second time period corresponds to the stage t3 in FIG. 7. In the stage t3, the first reset signal Vinit1 resets the third node N3 through the transistor T6 and the oxide transistor T4 to clear the residual charge in the previous frame of display images, and the threshold voltage of the transistor T3 may be adjusted to improve the accuracy of the driving current. The second time period lasts for at least one row scanning time, so that the charge on the third node N3 may be fully cleared.

Before the stage t3, the transistor T6 is turned on first, which may preheat the transistor T6 so that the transistor T6 is more fully turned on during the stage t3, in preparation for writing data to the fifth node N5.

After the stage t3, the transistor T6 is turned off first, which may prevent the threshold voltage of the transistor T6 from shifting due to voltage fluctuations, thereby improving the accuracy of subsequently writing data to the fifth node N5.

It will be noted that the driving method provided in the embodiments of the present disclosure is also applicable to the embodiments of FIGS. 9 and 10, and the embodiments of FIGS. 11 and 12.

In accordance with some embodiments, before the second time period, there is at least one third time period in which the isolation unit 105 and the first reset unit 107 are both turned on, and the driving method further includes: controlling, before the second time period, the first reset unit 107 to be turned on to transmit a first reset signal to the sixth node; and controlling, after the first reset unit 107 is turned on, the isolation unit 105 to be turned on for the at least one third time period to transmit the first reset signal to the fifth node, where the third time period lasts for at least one row scanning duration.

For example, in combination with FIGS. 6 and 7, a time period t2′ represents the third time period mentioned above. In the time period t2′, the first reset driving signal Reset_n is set to a high potential, the polysilicon transistor T5 in the isolation unit 105 and the transistor T6 in the first reset unit 107 are both turned on, and the first reset signal Vinit1 is written to the fifth node N5 through the polysilicon transistor T5, which may clear the residual charge on the fifth node N5. The gate stress of the transistor T3 in the driving unit 103 is adjusted to clear the influence of the previous frame of display images on its threshold voltage, thereby improving the accuracy of the driving current, and then alleviating the afterimage problem of the display screen. There may be multiple third time periods. By resetting the potential of the fifth node N5 multiple times, the residual charge on the fifth node N5 may be more fully cleared, thereby further reducing the possibility of the threshold voltage shift of the transistor T3.

It will be noted that the driving method provided in the embodiments of the present disclosure is also applicable to the embodiments of FIGS. 9 and 10, and the embodiments of FIGS. 11 and 12.

In accordance with some embodiments, the driving method further includes: controlling, before controlling the first light-emitting control unit 101 and the second light-emitting control unit 102 to be turned on, the first light-emitting control unit 101 to be turned on for at least one row scanning duration earlier than the second light-emitting control unit 102.

For example, in combination with FIGS. 11 and 12, the first light-emitting control unit 101 may include a transistor T1, the second light-emitting control unit 102 may include a transistor T2, a gate of the transistor T1 receives a first light-emitting control signal EM1, and a gate of the transistor T2 receives a second light-emitting control signal EM2.

The transistor T2 and the transistor T1 are both turned on, which corresponds to the stage t7 in FIG. 12. In the stage t7, the OLED enters a light-emitting state. Before the stage t7, i.e., the stage t6 in FIG. 12, the transistor T1 is turned on under the action of the first light-emitting control signal EM1, and the transistor T2 is turned off under the action of the second light-emitting control signal EM2. The first driving signal VDD can be written to the second node N2 and the third node N3 to pre-charge the transistor T3 in the driving unit 103.

It will be noted that by pre-charging the second node N2 in the stage t6, the pre-charged charge on the second node N2 may be quickly transferred to the capacitor of the OLED in the subsequent stage t7, thereby increasing the light-emitting rate of the OLED. Moreover, the stage t6 lasts for at least one row scanning duration to ensure sufficient pre-charging. The row scanning duration can be understood as a time interval between display images of adjacent frames.

In a third aspect, embodiments of the present disclosure provide a driving circuit for performing the driving method for the display panel of any embodiment in the second aspect.

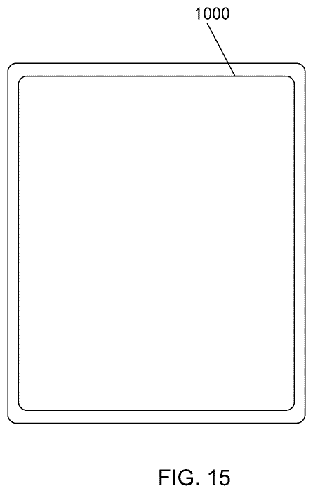

For example, FIG. 14 is a schematic structural block diagram of the connection relationship of a driving circuit provided in embodiments of the present disclosure. As shown in FIG. 14, the driving circuit may include an EOA (Emission Gate on Array) circuit and a GOA (Gate on Array) circuit. The EOA circuit is a light-emitting array driving circuit 200, which is used to provide a light-emitting control signal EM to the pixel circuit 100, taking FIG. 3 as an example. The GOA1 circuit is a first gate array driving circuit 300, used to provide a first gate driving signal, e.g., Ngate in FIG. 3, to the pixel circuit 100. The GOA2 circuit is a second gate array driving circuit 400, used to provide a second gate driving signal, e.g., Pgate in FIG. 3, to the pixel circuit 100.

It will be noted that the driving circuit may transmit control signals to the pixel circuit 100 under the control of a driving chip in the display panel, or under other control modes, such as a remote controller, etc., which is not specifically limited.

In a fourth aspect, embodiments of the present disclosure provide a display device. FIG. 15 is a schematic structural diagram of a display device provided in embodiments of the present disclosure. As shown in FIG. 15, the above-mentioned display device 1000 includes the display panel as in any embodiment in the first aspect, and/or the driving circuit as in the third aspect.

For example, the display device 1000 provided in the embodiments of the present disclosure may be applied to scenarios such as vehicle-mounted display, smart phones, computers, medical displays, televisions, smart wearable displays, etc., and the embodiments of the present disclosure do not make specific limitations.

It can be understood that the display device 1000 provided by the embodiments of the present disclosure includes the display panel of any embodiment in the first aspect, and thus possesses all the beneficial effects of the display panel, which need not be repeated here.

The above embodiments are only used to illustrate the technical solution of the present disclosure and are not intended to limit it. Although the present disclosure has been described in detail with reference to the aforementioned embodiments, those skilled in the art will appreciate that: modifications may be made to the technical solutions described in the foregoing embodiments, or equivalent replacements may be made to some of the technical features therein. Such modifications or replacements do not cause the essence of the corresponding technical solutions to depart from the spirit and scope of the technical solutions of various embodiments of the present disclosure.

What is claimed is:

1. A display panel, comprising a plurality of pixel circuits, wherein a pixel circuit of the plurality of pixel circuits comprising:
a first light-emitting control unit, wherein the first light-emitting control unit is electrically connected between a first node in the pixel circuit and a second node in the pixel circuit, and the first node is configured to receive a first driving signal;
a second light-emitting control unit, wherein the second light-emitting control unit is electrically connected between a third node in the pixel circuit and a fourth node in the pixel circuit;
a driving unit, wherein the driving unit is electrically connected to the second node, the third node and a fifth node in the pixel circuit;
a first data writing unit, wherein the first data writing unit is electrically connected between the third node and a sixth node in the pixel circuit, and the first data writing unit comprises an oxide transistor;
an isolation unit, wherein the isolation unit is electrically connected between the fifth node and the sixth node, and the isolation unit comprises a polysilicon transistor; and
a light-emitting unit, wherein one end of the light-emitting unit is electrically connected to the fourth node, and another end of the light-emitting unit is configured to receive a second driving signal;
wherein there is a first time period in which the first data writing unit and the isolation unit are both turned on, and after the first time period, the isolation unit is turned off before the first data writing unit.

2. The display panel according to claim 1, wherein the oxide transistor of the first data writing unit is in a saturation region in the first time period.

3. The display panel according to claim 1, wherein the oxide transistor of the first data writing unit is an N-type; and
the polysilicon transistor of the isolation unit is P-type;
wherein before the first time period, a rising edge of a gate signal of the oxide transistor is located before a falling edge of a gate signal of the polysilicon transistor;
after the first time period, a falling edge of the gate signal of the oxide transistor is located after a rising edge of the gate signal of the polysilicon transistor.

4. The display panel according to claim 1, wherein the pixel circuit further comprises:
a first reset unit, wherein the first reset unit is electrically connected to the sixth node, and the first reset unit is configured to transmit a first reset signal to the sixth node;
wherein there is a second time period in which the first data writing unit and the first reset unit are both turned on, before the second time period, the first reset unit is turned on before the first data writing unit, after the second time period, the first reset unit is turned off before the first data writing unit, and the second time period is non-overlapping with the first time period.

5. The display panel according to claim 4, wherein before the second time period, there is at least one third time period in which the isolation unit and the first reset unit are both turned on, and before each third time period, the first reset unit is turned on before the isolation unit.

6. The display panel according to claim 4, wherein the pixel circuit further comprises:
a second data writing unit, wherein the second data writing unit is electrically connected to the second node, and the second data writing unit is configured to transmit a data signal to the second node;
wherein the second data writing unit and the isolation unit have a same on or off state.

7. The display panel according to claim 6, wherein the pixel circuit further comprises:
a second reset unit, wherein the second reset unit is electrically connected to the fourth node, and the second reset unit is configured to transmit a second reset signal to the fourth node;
a third reset unit, wherein the third reset unit is electrically connected to the second node, and the third reset unit is configured to transmit a third reset signal to the second node; and
a capacitor, wherein one end of the capacitor is electrically connected to the first node, and another end of the capacitor is electrically connected to the fifth node.

8. The display panel according to claim 7, wherein the first reset unit comprises an oxide transistor; and/or
the second data writing unit comprises a polysilicon transistor; and/or
the second reset unit comprises a polysilicon transistor; and/or
the third reset unit comprises a polysilicon transistor; and/or
the first light-emitting control unit comprises a polysilicon transistor; and/or
the second light-emitting control unit comprises a polysilicon transistor; and/or
the driving unit comprises a polysilicon transistor.

9. The display panel according to claim 8, wherein the driving unit is a P-type polysilicon transistor, and a potential of the third reset signal is greater than a potential of the first driving signal; or
the driving unit is an N-type polysilicon transistor, and the potential of the third reset signal is less than the potential of the first driving signal.

10. The display panel according to claim 1, wherein the first light-emitting control unit is turned on for at least one row scanning duration before the second light-emitting control unit.

11. A driving method for a display panel, applied to the display panel according to claim 1, wherein the driving method comprises:
controlling the first data writing unit and the isolation unit to be turned on, enabling that there is the first time period in which the first data writing unit and the isolation unit are both turned on, and transmitting writing data to the driving unit;
controlling, after the first time period, the isolation unit to be turned off first and then the first data writing unit to be turned off; and
controlling the first light-emitting control unit and the second light-emitting control unit to be turned on, enabling the light-emitting unit to emit light under action of the first driving signal and the second driving signal.

12. The driving method for the display panel according to claim 11, wherein the pixel circuit comprises a first reset unit, and there is a second time period in which the first data writing unit and the first reset unit are both turned on and the driving method further comprises:
controlling, before the second time period, the first reset unit to be turned on first; and
controlling, after the second time period, the first reset unit to be turned off first;
wherein the second time period lasts for at least one row scanning duration.

13. The driving method for the display panel according to claim 12, wherein before the second time period, there is at least one third time period in which the isolation unit and the first reset unit are both turned on, and the driving method further comprises:
controlling, before the second time period, the first reset unit to be turned on to transmit a first reset signal to the sixth node; and
controlling, after the first reset unit is turned on, the isolation unit to be turned on for the at least one third time period to transmit the first reset signal to the fifth node, wherein each third time period lasts for at least one row scanning duration.

14. The driving method for the display panel according to claim 11, further comprising:
controlling, before controlling the first light-emitting control unit and the second light-emitting control unit to be turned on, the first light-emitting control unit to be turned on for at least one row scanning duration earlier than the second light-emitting control unit.

15. A driving circuit, for performing the driving method for the display panel according to claim 11.

16. A display device, comprising the display panel according to claim 1.

17. The driving circuit according to claim 15, wherein the driving circuit comprises:
a light-emitting array driving circuit, electrically connected to the pixel circuit and configured to provide a light-emitting control signal to the pixel circuit;
a first gate array driving circuit, electrically connected to the pixel circuit and configured to provide a first gate driving signal to the pixel circuit; and
a second gate array driving circuit, electrically connected to the pixel circuit and configured to provide a second gate driving signal to the pixel circuit.

18. A display device, comprising the driving circuit according to claim 15.

19. A display device, comprising the display panel according to claim 1 and a driving circuit for performing a driving method for the display panel, wherein the driving method comprises:
controlling the first data writing unit and the isolation unit to be turned on, so that there is the first time period in which the first data writing unit and the isolation unit are both turned on, and transmitting writing data to the driving unit;
controlling, after the first time period, the isolation unit to be turned off first and then the first data writing unit to be turned off; and
controlling the first light-emitting control unit and the second light-emitting control unit to be turned on, so that the light-emitting unit emits light under action of the first driving signal and the second driving signal.
